(19) United States
(12) Patent Application Publication
(10) Pub. No.: US 2013/0305249 A1
(43) Pub. Date: Nov. 14, 2013

(54) ELECTRONIC INFORMATION TERMINAL AND ELECTRONIC INFORMATION SYSTEM

(71) Applicants: Ikue Kawashima, Kanagawa (JP); Mayuka Araumi, Tokyo (JP)

(72) Inventors: Ikue Kawashima, Kanagawa (JP); Mayuka Araumi, Tokyo (JP)

(21) Appl. No.: 13/997,813

(22) PCT Filed: Dec. 5, 2011
(86) PCT No.: PCT/JP2011/078627

§ 371 Date: Jun. 25, 2013

(30) Foreign Application Priority Data
Dec. 28, 2010 (JP) 2010-294014

(51) Int. Cl. G06F 9/46

(52) U.S. Cl. CPC G06F 9/46
USPC 718/100

(57) ABSTRACT

A disclosed electronic information terminal includes a main control unit to control an overall function of the terminal, a storage unit to store various data and programs, a display unit to display a fixed format including input items, an input unit to input information into the corresponding input items, a communication control unit to establish a communication network between the input unit and a server, an input completion detector unit to detect completion of input operations in which the information corresponds to the input items of the fixed format, and a process execution unit to execute a process subsequent to the input operations. When the input completion detector unit detects the completion of the input operations, the process execution unit executes the process subsequent to the input operations.

### TECHNICAL FIELD

The embodiments discussed herein are related to an electronic information terminal and an electronic information system.

### BACKGROUND ART

In the field of document exchange systems, submissions of various applications to public institutions or companies have increasingly been carried out without paper and such paperless submissions have been widely used, and communications by the paper medium have been encouraged to be replaced with the communications by the electronic information transmissions. For example, various electronic communication techniques, such as communications utilizing groupware, electronic mail, WEB browsers or ASPs (Active Server Pages), have been proposed and have actually been put into practical use.

One example of devices practically and widely utilized for paperless submissions may be a display provided with a memory function such as an electronic book terminal, or a so-called tablet electronic information terminal having a nonvolatile display. In addition, there has been developed an electronic information system for registering customer information and the like utilizing such a tablet electronic information terminal. The tablet electronic information terminal mainly includes a main control unit configured to integrally control an overall device (i.e., the tablet electronic information terminal), a storage unit configured to store various data and programs, a display unit of the aforementioned nonvolatile display or display provided with a memory function, and a communication control unit configured to establish (or construct) a communication network between a server and an input unit of the tablet electronic information terminal, such as a digitizer pen disclosed, for example, in Japanese Patent Application Laid-Open Publication No. 2006-139643 (hereinafter called “Patent Document 1”) and Japanese Patent Application Laid-Open Publication No. 2007-279961 (hereinafter called “Patent Document 2”), which is configured to directly input information via a display screen of the tablet electronic information terminal.

Further, Japanese Patent Application Publication No. 2008-015864 (hereinafter called “Patent Document 3”) discloses a method of inputting information into such a tablet electronic information terminal. According to the method disclosed in Patent Document 3, a fixed format, such as an application for a credit card, is displayed by a page unit on a display screen surface of the display unit, and an applicant (or a user) is prompted to input appropriate information for each of input items (i.e., items that require the user's information) displayed on the page, such as an address or a telephone number. The customer information is registered into the server by the user's input operations to input corresponding information. When the user completes inputting of information corresponding to input items of all the pages, and then presses a “data transmission” button, all the information input by the user is simultaneously transmitted to the server. When the server receives all the items of the information transmitted by the tablet electronic information terminal (i.e., triggered by the user's pressing of the button), the server determines whether all the transmitted information corresponding to the input items includes missing parts, and whether the transmitted information corresponding to the input items is valid. If the server detects invalid information corresponding to a certain input item, the server transmits an “invalid result” to the tablet electronic information terminal and displays a message on the display to prompt the user to re-input correct information corresponding to that input item. Thereafter, the user re-inputs the information corresponding to the item and presses the “data transmission button” to transmit all the information again to the server, and the server determines whether all the transmitted information corresponding to the input items is valid again. When the server determines that all the transmitted information corresponding to the input items is valid (i.e., approved), the server stores the information corresponding to all the input items of all pages in either the server itself or the storage unit of the tablet electronic information terminal. The submission of the application is completed in this manner.

However, in the technology disclosed in Patent Document 3, the user needs to press a “page forwarding button” to move to a next page if there is such a subsequent page. Further, when the user desires to transmit all the input information corresponding to the input items simultaneously and allow the server to determine the validity of the input (transmitted) information, the user presses the “data transmission button” to transmit all the input information corresponding to the input items to the server. As described above, in the technology disclosed in Patent Document 3, the user needs to press a predetermined button every time the user desires to execute a certain kind of a process subsequent to his or her input operations (for inputting information corresponding to the input items), such as pressing a “page forwarding button” to execute a page forwarding process to move to the next page after the user's input operations and pressing the “data transmission button” to execute a data transmission process to transmit the input information after the user completes inputting of the information corresponding to the input items of all the pages, which may make the user's operability of the terminal or device cumbersome. In addition, in the technologies disclosed in Patent Document 1 and Patent Document 2 other than Patent Document 3, the user also needs to press a predetermined button to execute an additional process subsequent to the user's inputting operations to execute a validity determination process other than the page forwarding process and the data transmission process in a similar manner to that of the technology disclosed in Patent Document 3.

It is a general object of at least one embodiment of the present invention to provide an electronic information terminal and an electronic information system that are capable of executing a post-process after an input process without a user's operation of pressing a predetermined instruction button that substantially eliminates one or more problems caused by the limitations and disadvantages of the related art.

### SUMMARY OF THE INVENTION

According to one embodiment, there is provided an electronic information terminal that includes a main control unit configured to control an overall function of the electronic information terminal; a storage unit configured to store various data and programs; a display unit configured to display a fixed format including input items by a page unit; an input unit configured to input information into input areas corresponding to the input items of the fixed format displayed on the display unit; a communication control unit configured to establish a communication network between the input unit and at least one server; an input completion detector unit configured to detect completion of input operations in which the information corresponding to the input items of the fixed format displayed on the display unit is input by the input unit; and a process execution unit configured to execute at least one process subsequent to the input operations performed by the input unit. In the electronic information terminal, when the input completion detector unit detects the completion of the input operations in which the information corresponding to the input items of the fixed format displayed on the display unit is input by the input unit, the process execution unit executes the at least one process subsequent to the input operations performed by the input unit.

According to another embodiment, there is provided an electronic information system that includes at least one electronic information terminal; and at least one server connected to the electronic information terminal via a network. The electronic information terminal includes a main control unit configured to control an overall function of the electronic information terminal; a storage unit configured to store various data and programs; a display unit configured to display a fixed format including input items by a page unit; an input unit configured to input information into input areas corresponding to the input items of the fixed format displayed on the display unit; a communication control unit configured to establish a communication network between the input unit and at least one server; an input completion detector unit configured to detect completion of input operations in which the information corresponding to the input items of the fixed format displayed on the display unit is input by the input unit; and a process execution unit configured to execute at least one process subsequent to the input operations performed by the input unit.

### BRIEF DESCRIPTION OF THE DRAWINGS

Other objects and further features of embodiments will be apparent from the following detailed description when read in conjunction with the accompanying drawings, in which:

FIG. 1 is a perspective diagram illustrating a configuration of an electronic information terminal according to an embodiment;

FIG. 2 is a schematic diagram illustrating a configuration of an electronic information system;

FIG. 3 is a schematic diagram illustrating an input operation of the electronic information terminal according to the embodiment; and

FIG. 4 is a flowchart illustrating a process of the input operation of the electronic information terminal according to the embodiment.

### BEST MODE OF CARRYING OUT THE INVENTION

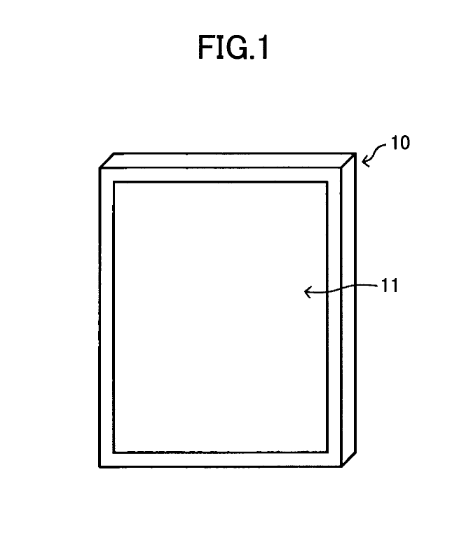

Preferred embodiments are described below with reference to the accompanying drawings. FIG. 1 is a perspective diagram illustrating a configuration of an electronic information terminal according to an embodiment. As illustrated in FIG. 1, an electronic information terminal 10 includes a display 11 configured to display a fixed format, an error message or a guide message. In the display 11 of the electronic information terminal 10, information may be input by a user's touching of a screen surface (hereinafter also called a “display screen”) or handwritten characters may be input by the user's operating of an input unit such as a digitizer. The display 11 of the electronic information terminal 10 is with a memory function or a nonvolatile display. Such a display provided with a memory function or nonvolatile display is configured to store data displayed on the display screen and continuously display such data based on the stored data without power supply. The electronic information terminal 10 further includes a not-illustrated CPU (Central Processing Unit) configured to control a memory that stores various programs, carry out arithmetic processes on information if the input information is processed by the electronic information terminal 10 itself and control an overall configuration of the electronic information terminal 10, and an interface configured to connect the electronic information terminal 10 to a network for establishing a communication line with the server.

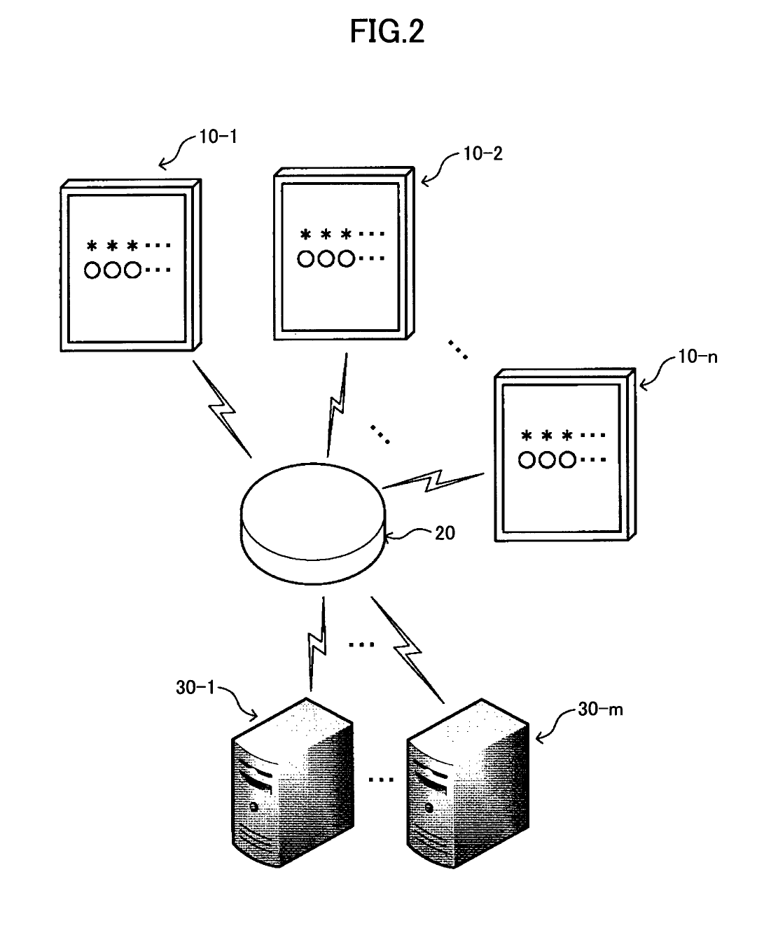

FIG. 2 illustrates an electronic information system composed of plural of the electronic information terminals 10 and servers 30 that are connected via a network 20. As illustrated in FIG. 2, the electronic information terminals 10-1 to 10-n (n is a positive integer) are connected to the servers 30-1 to 30-m (m is a positive integer) via the network 20. If input information supplied to the electronic information terminals 10-1 to 10-n is attached data such as handwritten signature data, the electronic information terminals 10-1 to 10-n transmit the attached data to the corresponding servers 30-1 to 30-m via the network 20, which in turn carry out the arithmetic processes on the input information of the attached data received by the corresponding servers 30-1 to 30-m, and determine whether the input information of the attached data received by the corresponding servers 30-1 to 30-m is valid. Note that the arithmetic process may be carried out on the attached data by the corresponding servers 30-1 to 30-m in a distributed fashion, based on the amount of information contained in the attached data or levels of importance of such information contained in the attached data.

Further, in this embodiment, the input information input by the user utilizing the input device is data to be processed by the electronic information terminal 10 and an electronic information system according to the embodiments. The data to be processed may be divided into two, namely, check data and attached data. The check data contain relatively little information and are easy to process, whereas the attached data contain a relatively large amount of information. An example of the check data includes data indicating the presence or the absence of input information in a corresponding inputting field, the presence or the absence of a check mark, whether the number of check marks exceeds a predetermined number (i.e., limitation), and whether the input information is identifiable characters, numbers or symbols. An example of the attached data includes image data of handwritten characters, stroke data of handwritten characters (i.e., the directions in which the strokes are drawn, and writing pressures), location of the check mark (predetermined input filed or other areas), image data of characters or symbols written in extra areas other than the input field (input area), date and time of the input information corresponding to each input item, and a search result of an address searched for by using a postal code as a key.

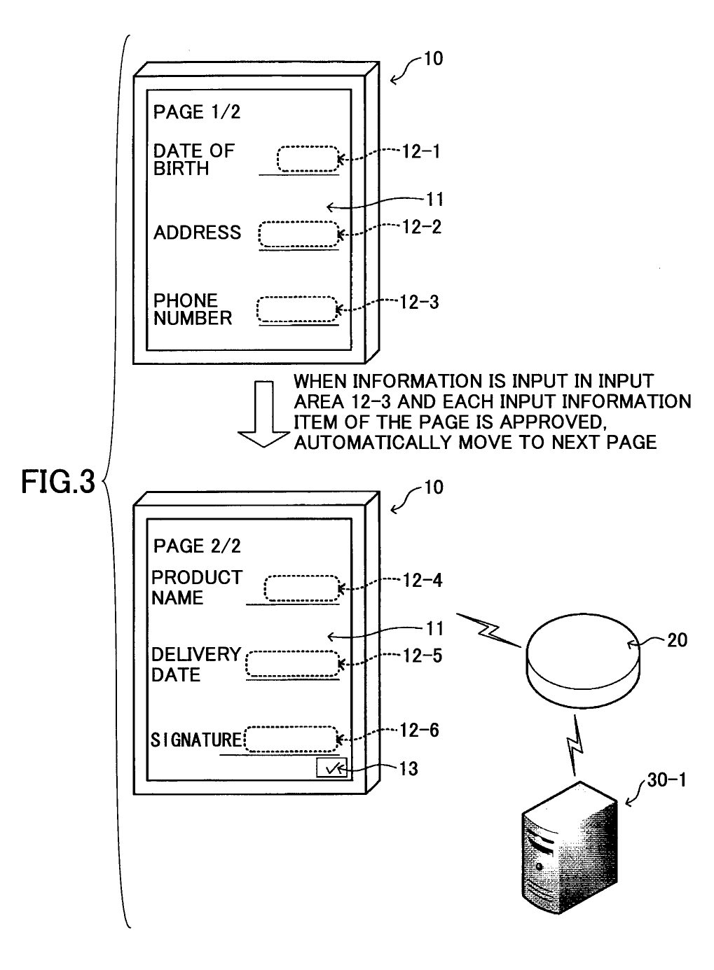

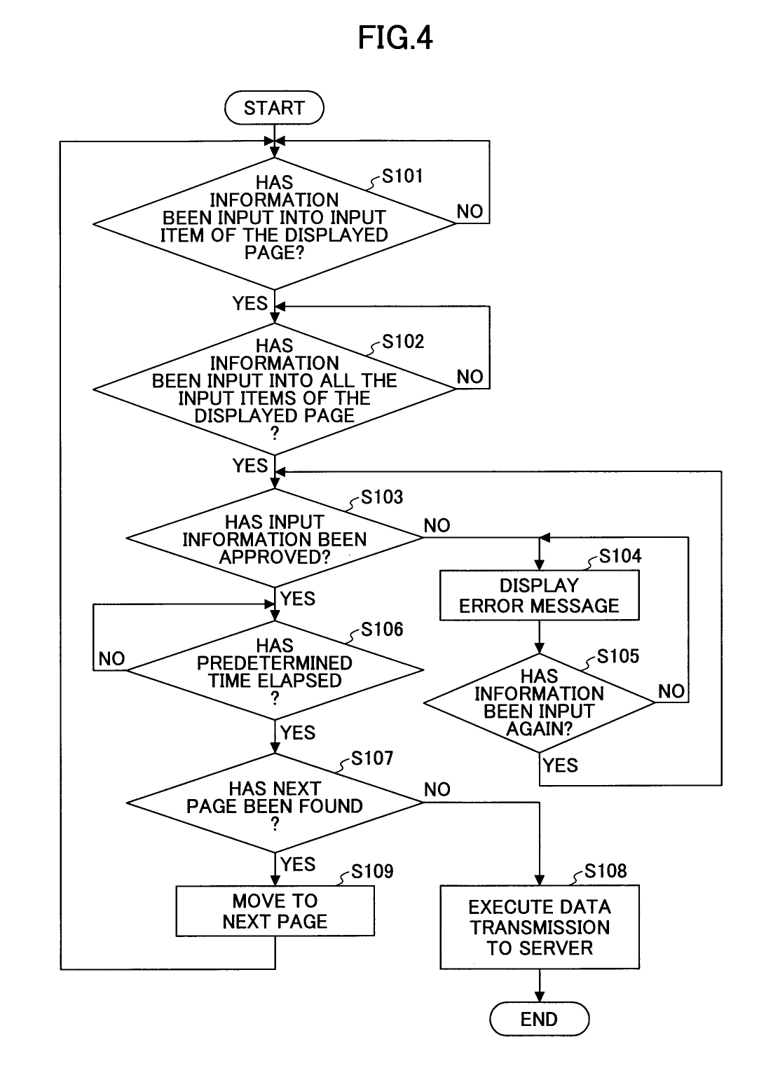

Next, a description is given of an example of an input operation utilizing the electronic information terminal 10 according to the embodiment. FIG. 3 is a schematic diagram illustrating an example of the input operation of the electronic information terminal 10 according to the embodiment. FIG. 4 is a flowchart illustrating a process of the input operation of the electronic information terminal 10 according to the embodiment. First, a first page of a fixed format is displayed on the display 11 of the electronic information terminal 10 as illustrated in apart (a) of FIG. 3. In this example, the fixed format includes a total number of two pages. In the fixed format, handwritten input information or numeric information selected from numeric candidates for “Day”, “Month”, and “Year” items is input into an area 12-1 that is an input field of a date of birth input item, and similarly, corresponding information is input into areas 12-2 and 12-3 of respective input items (step S101). After the information is input into the area 12-3 that is the last input item on the first page, which indicates that the corresponding information is input for all the input items on the first page, or after a check mark is input into a check box 13 (see part (b) of FIG. 3) indicating the completion of the input operations displayed on the display 11, whether the input information corresponding to all the input items is valid is determined (“YES” in step S102 and step S103). Note that in this embodiment, the validity determination is carried out by the electronic information terminal 10 itself. This is because the amount of the validity determination data corresponding to the input information is small or the validity determination is assumed to be simple in the electronic information terminal 10. However, if the amount of the validity determination data corresponding to the input information is large or the validity determination is complicated, the input information may be transmitted to the corresponding server 30, and the validity determination may be carried out by that server 30. After the validity determination is carried out, an error message may be displayed on the display 11 as a result of an invalidity determination in order to prompt (encourage) the user to input correct (valid) information (“NO” in step S103 and step S104). Thereafter, the error message is repeatedly displayed until information is input into the corresponding area again (“NO” in step S105). If the information is input into the corresponding area again (“YES” in step S105), whether the input information input into the corresponding area again is valid is determined again (back to step S103). If the input information is valid and a predetermined time has elapsed (“YES” in step S103 and “YES” in step S106), whether there is a next page (any subsequent page) is determined. If there is the next page (i.e., a second page in this case) (“YES” in step S107), the current page is moved to the next page so that the displayed screen displays the second (next) page (step S109), and the same process is repeated from step S101 (back to step S101). Thereafter, if there is no subsequent page after all the information input into the corresponding fields of all the input items displayed on the second page and all the input information has been determined as valid information (“NO” in step S107), all the input information is transmitted to the corresponding server (step S108).

Note that in this embodiment, the validity determination is carried out for each page. However, the validity determination may be carried out simultaneously for all the pages after the information is input into the corresponding fields of all the items of the total number of pages. In this configuration, if there is a page including invalid input information corresponding to a certain input item, the display screen automatically switches to the page containing the invalid input information and displays an error message or a message to prompt the user to input correct information. Further, in this embodiment, the subsequent page (next page) is displayed or the input data are transmitted after the information is input into the last input item of the page and then a predetermined time has elapsed. However, the subsequent (next) page may not be displayed or the input data may not be transmitted after the information is input into the last input item of the page and then the predetermined time has elapsed after the information is input into the last input item of the page. The subsequent page may be displayed instantaneously or the input data may be transmitted instantaneously without allowing a predetermined time to elapse insofar as the user is accustomed to operations of the electronic information terminal 10. That is, the predetermined time may optionally be changed and set to any time including “0” time. Further, in the validity determination in this embodiment, simple validity determination is carried out in which whether there is a blank field (i.e., no information is input into an input area), whether a check mark is missing out, whether the number of input characters exceeds the predetermined limitation and whether the allowable types of characters are used as the input characters are determined.

As described above, the electronic information terminal 10 according to the above embodiment includes the main control unit configured to integrally control an overall function of the electronic information terminal 10, a storage unit configured to store the various data and programs, the display 11 configured to display information directly input via a display screen of the display 11 (i.e., a display unit), and the communication control unit configured to establish the network between the server and the input unit with which the user directly inputs information via the display screen of the display 11 as illustrated in FIG. 1. The display 11 includes the memory function. The display 11 further includes a function to receive handwritten characters input by the input unit such as the digitizer. In the electronic information terminal 10 having such a configuration, a fixed format may be displayed on the display 11, and information is input into the input areas by utilizing the input unit corresponding to the input items for each page. Thereafter, when the electronic information terminal 10 detects the completion of the input operations to input the information in the areas (fields) corresponding to the input items of each page, the electronic information terminal 10 determines whether the input information for each item is valid. If the determination result indicates the input information for all the input items as valid information and there is a subsequent page, the next (subsequent) page is automatically displayed (i.e., the next page is automatically moved to become the current page) after the predetermined time has elapsed. If there is no subsequent page, the input information is automatically transmitted to the corresponding server after the predetermined time has elapsed. With this configuration, the user may not be required to press the page forwarding button or the data transmission button. Accordingly, the electronic information terminal 10 having such a configuration may exhibit superior operability.

In the electronic information terminal 10 according to the above embodiment, information is supplied to the areas corresponding to the input items of the fixed format of the pages displayed on the display unit. Further, in the electronic information terminal 10 according to the above embodiment, when an input completion detector unit detects the completion of the information input operations for the areas corresponding to all the input items of the pages, a process execution unit executes an appropriate one of processes subsequent to the input operations, such as a page forwarding process, the data transmission process, or the validity determination process. Specifically, the process execution unit includes a page forwarding unit configured to carry out the page forwarding process to move a subsequent page (i.e., next page) to become the current page, a validity determination unit configured to carry out the validity determination process to determine whether the input information is valid, and a transmitting and receiving unit configured to carry out the data transmission process to transmit the input information to the corresponding server and to receive a validity determination result of the input information. With this configuration, the user may not have to press the predetermined instruction buttons to execute the processes subsequent to the input operations such as the page forwarding process, the validity determination process, and the information transmitting and receiving processes.

The electronic information terminal and the electronic information system according to the above embodiment may provide an excellent effect for eliminating cumbersome operations for the user to press the predetermined instruction buttons in order to execute the processes subsequent to the input operations, such as the page forwarding process, the validity determination process, and the information transmitting and receiving processes.

According to one embodiment, there is provided an electronic information terminal that includes a main control unit configured to control an overall function of the electronic information terminal; a storage unit configured to store various data and programs; a display unit configured to display a fixed format including input items by a page unit; an input unit configured to input information into input areas corresponding to the input items of the fixed format displayed on the display unit; a communication control unit configured to establish a communication network between the input unit and at least one server; an input completion detector unit configured to detect completion of input operations in which the information corresponding to the input items of the fixed format displayed on the display unit is input by the input unit; and a process execution unit configured to execute at least one process subsequent to the input operations performed by the input unit. In the electronic information terminal, when the input completion detector unit detects the completion of the input operations in which the information corresponding to the input items of the fixed format displayed on the display unit is input by the input unit, the process execution unit executes the at least one process subsequent to the input operations performed by the input unit.

In the electronic information terminal according to the embodiment, the process execution unit includes a page forwarding unit configured to move a subsequent page of the fixed format to become the current page, a validity determination unit configured to determine whether the information input by the input unit corresponding to the input items of the fixed format displayed on the display unit is valid as a validity determination result of the input information, and a transmitting and receiving unit configured to transmit the input information corresponding to the input items of the fixed format displayed on the display unit to the server and receive a validity determination result of the input information from the server.

The electronic information terminal according to the embodiment further includes a validity determination unit configured to determine whether the input information input by the input unit corresponding to the input items of the fixed format displayed on the display unit is valid as a validity determination result of the input information; and a transmitting and receiving unit configured to transmit the input information corresponding to the input items of the fixed format displayed on the display unit to the server and receive a validity determination result of the input information from the server.

In the electronic information terminal according to the embodiment, if the input information is check data, the validity determination unit determines whether the check data are valid as the validity determination result of the input information, and if the input information is attached data, the transmitting and receiving unit transmits the input information to the server and receive the validity determination result of the input information from the server.

In the electronic information terminal according to the embodiment, the check data include a small amount of data, are simple to process, and formed of data indicating presence or absence of the input information corresponding to the input items, data indicating presence or absence of a check mark indicating the completion of the input operations, data indicating whether a number of the check marks exceeds a predetermined number, and data indicating whether the input information contains allowable types of characters.

In the electronic information terminal according to the embodiment, the attached data include a large amount of data, are complicated to process, and formed of image data of handwritten characters, stroke data of the handwritten characters, image data of characters or symbols input into extra areas other than the input areas corresponding to the input items of the fixed format, and date and time data of the input information.

In the electronic information terminal according to the embodiment, if one of the validity determination result of the input information determined by the validity determination unit and the validity determination result of the input information received by the transmitting and receiving unit from the server indicates that the input information is invalid, the display unit displays an error message corresponding to the input information that is determined as invalid.

The electronic information terminal according to the embodiment further includes a page forwarding unit configured to move, if there is a page subsequent to a current page of the fixed format, the subsequent page of the fixed format to become the current page after the input information is input into the current page of the fixed format by the input unit and a predetermined time has elapsed; and a transmitting and receiving unit configured to transmit, if there is no subsequent page subsequent to the current page of the fixed format, the input information corresponding to the input items of the fixed format to the server.

In the electronic information terminal according to the embodiment, the predetermined time is optionally set.

In the electronic information terminal according to the embodiment, the display unit further includes a handwritten input function configured to receive handwritten information.

In the electronic information terminal according to the embodiment, the display unit includes a memory function.

According to another embodiment, there is provided an electronic information system that includes at least one electronic information terminal; and at least one server connected to the electronic information terminal via a network.

Embodiments of the present invention have been described heretofore for the purpose of illustration. The present invention is not limited to these embodiments, but various variations and alterations may be made without departing from the scope of the present invention. The present invention should not be interpreted as being limited to the embodiments that are described in the specification and illustrated in the drawings.

The present application is based on Japanese Priority Application No. 2010-294014 filed on Dec. 28, 2010, with the Japanese Patent Office, the entire contents of which are hereby incorporated by reference.

1. An electronic information terminal, comprising:
a main control unit configured to control an overall function of the electronic information terminal;
a storage unit configured to store various data and programs;
a display unit configured to display a fixed format including input items by a page unit;
an input unit configured to input information into input areas corresponding to the input items of the fixed format displayed on the display unit;
a communication control unit configured to establish a communication network between the input unit and at least one server;
an input completion detector unit configured to detect completion of input operations in which the information corresponding to the input items of the fixed format displayed on the display unit is input by the input unit; and
a process execution unit configured to execute at least one process subsequent to the input operations performed by the input unit, wherein
when the input completion detector unit detects the completion of the input operations in which the information corresponding to the input items of the fixed format displayed on the display unit is input by the input unit, the process execution unit executes the at least one process subsequent to the input operations performed by the input unit.

2. The electronic information terminal as claimed in claim 1, wherein
the process execution unit includes a page forwarding unit configured to move a subsequent page of the fixed format to become a current page, a validity determination unit configured to determine whether the information input by the input unit corresponding to the input items of the fixed format displayed on the display unit is valid as a validity determination result of the input information, and a transmitting and receiving unit configured to transmit the input information corresponding to the input items of the fixed format displayed on the display unit to the server and receive a validity determination result of the input information from the server.

3. The electronic information terminal as claimed in claim 1, further comprising:
a validity determination unit configured to determine whether the input information input by the input unit corresponding to the input items of the fixed format displayed on the display unit is valid as a validity determination result of the input information; and
a transmitting and receiving unit configured to transmit the input information corresponding to the input items of the fixed format displayed on the display unit to the server and receive a validity determination result of the input information from the server.

4. The electronic information terminal as claimed in claim 3, wherein
if the input information is check data, the validity determination unit determines whether the check data are valid as the validity determination result of the input information, and
if the input information is attached data, the transmitting and receiving unit transmits the input information to the server and receive the validity determination result of the input information from the server.

5. The electronic information terminal as claimed in claim 4, wherein
the check data include a small amount of data, are simple to process, and formed of data indicating presence or absence of the input information corresponding to the input items, data indicating presence or absence of a check mark indicating the completion of the input operations, data indicating whether a number of the check marks exceeds a predetermined number, and data indicating whether the input information contains allowable types of characters.

6. The electronic information terminal as claimed in claim 4, wherein
the attached data include a large amount of data, are complicated to process, and formed of image data of handwritten characters, stroke data of the handwritten characters, image data of characters or symbols input into extra areas other than the input areas corresponding to the input items of the fixed format, and date and time data of the input information.

7. The electric element as claimed in claim 2, wherein
if one of the validity determination result of the input information determined by the validity determination unit and the validity determination result of the input information received by the transmitting and receiving unit from the server indicates that the input information is invalid, the display unit displays an error message corresponding to the input information that is determined as invalid.

8. The electronic information terminal as claimed in claim 1, further comprising:
a page forwarding unit configured to move, if there is a page subsequent to a current page of the fixed format, the subsequent page of the fixed format to become the current page after the input information is input into the current page of the fixed format by the input unit and a predetermined time has elapsed; and a transmitting and receiving unit configured to transmit, if there is no subsequent page subsequent to the current page of the fixed format, the input information corresponding to the input items of the fixed format to the server.

9. The electronic information terminal as claimed in claim 8, wherein
the predetermined time is optionally set.

10. The electric element as claimed in claim 1, wherein
the display unit further includes a handwritten input function configured to receive handwritten information.

11. The electric element as claimed in claim 1, wherein
the display unit includes a memory function.

12. An electronic information system comprising:
at least one of the electronic information terminals as claimed in claim 1; and
at least one of the servers connected to the electronic information terminal via the network.
